(19) United States
(12) Patent Application Publication
(10) Pub. No.: US 2008/0316312 A1
(43) Pub. Date: Dec. 25, 2008

(54) SYSTEM FOR CAPTURING VIDEO OF AN ACCIDENT UPON DETECTING A POTENTIAL IMPACT EVENT

(76) Inventors: Francisco Castillo, Brooklyn, NY (US); Tommy Lee Jones, Whittier, CA (US); Jose Luis Chavez, Pomona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/766,732

(22) Filed: Jun. 21, 2007

(51) Int. Cl. H04N 7/18

(52) U.S. Cl. 348/148; 340/436; 348/E07.09

(57) ABSTRACT

A system and method for monitoring a vehicle and obtaining video of an accident or other criminal incident are described. An embodiment of the system includes one or more cameras mounted on a vehicle, a wireless transmitter, and a contact detection system comprising a processor in electrical communication with the one or more cameras, the wireless transmitter and one or more sensors configured to detect a potential contact event, wherein the processor is configured to receive an indication in response to one or more of the sensors detecting the potential contact event, activate at least one of the cameras to capture video data subsequent to receiving the indication of the potential contact event, determine whether or not the contact event occurs and discard the captured video data in response to determining that the contact event did not occur.

### BACKGROUND OF THE INVENTION

1. Field of the Invention

The invention relates vehicle monitoring systems, more particularly, the invention relates to a system for capturing video preceding and subsequent to an impact event or other criminal incident.

2. Description of the Related Technology

Vehicle security systems have been proven to rarely prevent a vehicle from being vandalized or stolen. Vehicle alarms, for example, can be disabled quickly leaving them useless. Vehicle tracking systems can be effective, but often times the authorities arrive after the vehicle has been stripped and the perpetrators are no longer present. What is needed is a vehicle monitoring system that records and quickly alerts an owner of the vehicle with visual and/or audio evidence obtained prior to and during an incident.

### SUMMARY OF CERTAIN INVENTIVE ASPECTS

The systems and methods of the invention each have several aspects, no single one of which is solely responsible for its desirable attributes. Without limiting the scope of this invention as expressed by the claims which follow, its more prominent features will now be discussed briefly.

An aspect provides a system including one or more cameras mounted on a vehicle, a wireless transmitter, and a contact detection system comprising a processor in electrical communication with the one or more cameras, the wireless transmitter and one or more sensors configured to detect a potential contact event, wherein the processor is configured to receive an indication in response to one or more of the sensors detecting the potential contact event, activate at least one of the cameras to capture video data subsequent to receiving the indication of the potential contact event, determine whether or not the contact event occurs and discard the captured video data in response to determining that the contact event did not occur.

Another aspect provides a system including a camera rotatably mounted on a vehicle, and a motion detection system comprising a processor in electrical communication with the camera, and one or more motion sensors configured to detect motion of an object in the vicinity of the vehicle, wherein the processor is configured to receive an indication from one or more of the sensors subsequent to detecting the motion of the object, to rotate the camera to point in the direction of the area monitored by the motion sensor that detected the motion of the object, and to activate the camera subsequent to receiving the motion indication.

Another aspect provides a method including detecting a potential contact event of a vehicle, receiving an indication of the detection of the potential contact event, activating one or more cameras to capture video data subsequent to receiving the indication of the potential contact event, determining whether or not the contact event occurs, and discarding the captured video data in response to determining that the contact event did not occur.

Another aspect provides a method including detecting motion of an object in the vicinity of a vehicle with one or more motion sensors, receiving an indication from at least one of the motion sensors subsequent to detecting the motion of the object, rotating a camera to point in the direction of the area monitored by the motion sensor that detected the motion of the object, and activating the camera subsequent to receiving the motion indication.

### BRIEF DESCRIPTION OF THE DRAWINGS

FIG. 1 shows an embodiment of a system for capturing video of an incident in a four door automobile.

FIG. 2A is a schematic diagram of an embodiment of a multiple camera system such as illustrated in FIG. 1.

FIG. 2B is a schematic diagram of an embodiment of a rotating camera system such as illustrated in FIG. 1.

FIG. 3 is a flowchart illustrating an example of a method of capturing video of an incident in a system such as illustrated in FIG. 1.

FIG. 4 is a flowchart illustrating an example of a method of monitoring the surroundings of a vehicle in a system such as illustrated in FIG. 1.

The Figures are schematic only, not drawn to scale.

### DETAILED DESCRIPTION OF CERTAIN EMBODIMENTS

The following detailed description is directed to certain specific sample aspects of the invention. However, the invention can be embodied in a multitude of different ways as defined and covered by the claims. In this description, reference is made to the drawings wherein like parts are designated with like numerals throughout.

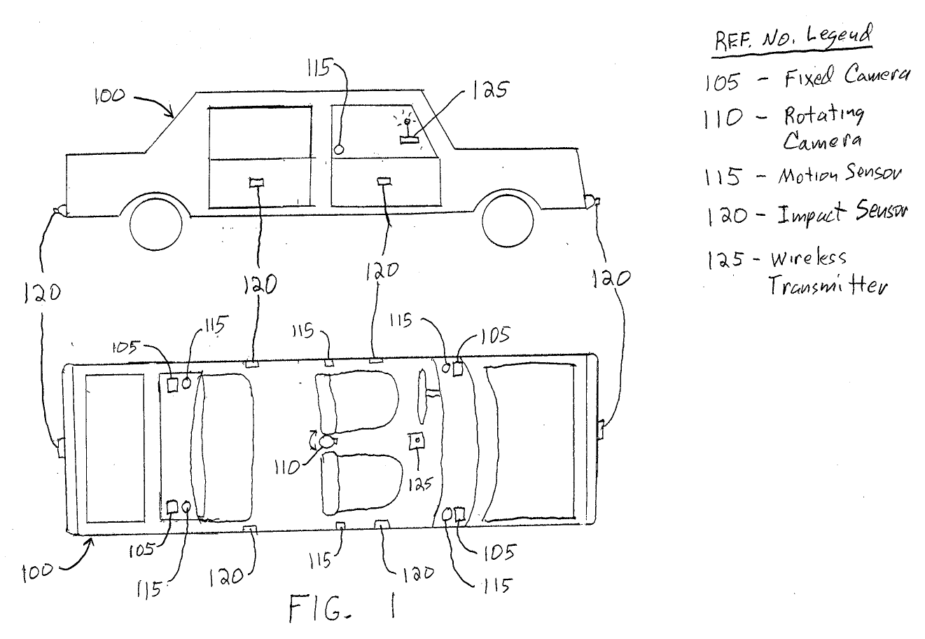

FIG. 1 shows an embodiment of a system for capturing video of an incident in a four door automobile. The vehicle 100 is a four door sedan in this example, but other vehicles may also be provided for. The views in FIG. 1 include a passenger's side view and a top view with the roof removed to show the interior. The vehicle 100 includes several components of a monitoring system for capturing video of an accident or other incident such as a break-in or vandalism. The monitoring system embodiment includes four fixed cameras 105, one rotating camera 110, six motion sensors 115, six impact sensors 120 and a wireless transmitter 125.

The four fixed cameras 105 in this embodiment are mounted on the forward and back dashboards. The fixed cameras 105 are positioned such that their field of view is directed at the distal corner away from the windows that they are closest to. For example, the fixed camera 105 located in the right (or passenger's side) rear corner of the back dash is positioned such that its field of view generally points to toward the left (or driver's side) front corner. This positioning allows for the widest viewing angle encompassing both the interior and the exterior of the vehicle 100. In some vehicles, the seats and/or headrests may obscure the view of fixed cameras mounted on the dashboards. In these vehicles the fixed cameras 105 may be mounted on the underside of the roof or on vertical roof supports in the corners of the car.

The fixed cameras 105 may be any type of recording camera capable of communicating the recorded video and possibly audio to a microcontroller. The video may be analog, but digital video is preferred. In one embodiment, the fixed cameras 105 are IP (Internet protocol) addressable cameras that can be monitored remotely, e.g., over the Internet. The cameras in the embodiment of FIG. 1 were mounted inside the vehicle 100, but some cameras could be mounted outside of the vehicle. For example, cameras could be mounted in side view mirror housings or in an antenna mount.

The rotating camera 110 is located in the center of the car such that it can be rotated to a portion of the car where one of the motion sensors 115 or impact sensors 120 has indicated that something is approaching the car or has impacted the car. In one embodiment, the rotating camera 110 is mounted on a pole positioning it above the seats and head rests, thereby providing a clear view in all directions. In another embodiment, the rotating camera 110 is mounted on the interior of the roof. The rotating camera 110 may also be mounted outside of the vehicle. Both the fixed cameras 105 and the rotating camera 110 may be used in the same system, but both are not necessary in the same system.

Four of the six motion sensors 115 are located in similar locations to the fixed cameras 105. The motion sensors in the example are directional and they are directed in a similar direction to the cameras such that the area that they are sensing motion in is similar to the view of the camera. For example, the motion sensor 115 located in the left rear dashboard is positioned such that it senses motion in the direction of the right front dashboard. In the embodiment illustrated in FIG. 1, the motion sensors 115 exhibited a smaller sensitivity region than the viewing region of the fixed cameras 105. Because of this, the motion sensors 105 were unable to detect motion in regions between the rear and front doors. For this reason two more motion sensors 115 were positioned inside the driver's and passengers windows towards the rear of the windows. These two motion sensors 115 were positioned such that they sensed motion in a region extending out generally perpendicular to the sides of the vehicle 100.

The motion sensors 115 could be a standard type of motion sensor, e.g., an infrared sensor, used in home security systems or those used for turning on lights when entering a room. In these motion sensors, the frequency of the feedback signal changes according to the position of the object. In another embodiment, the motion sensors 115 comprise an infrared LED (light emitting diode) and a phototransistor configured to measure the infrared light from the LED that bounces off an object. In this embodiment, the current of the phototransistor changes when the reflected light changes. A suitable phototransistor is the L14G2 hermetic silicon phototransistor manufactured by Fairchild Semiconductor. A suitable infrared LED is the P-N Galium Arsenide Infrared LED number TIL31B from Texas Instruments. Other infrared LED's and phototransistors known to skilled technologists may also be used.

In another embodiment, the motion sensors 115 can be omitted and the images captured from the cameras 105 and/or 110 can be analyzed to identify objects that appear in the views of the cameras that were not present in previous captured images. The sensitivity of the object detection can be regulated by filtering the captured images or by changed the focus of the cameras such that they are less sensitive. In this way, false detections can be reduced.

Six impact sensors 120 are positioned at various locations around the vehicle 100. One impact sensor 120 is located on rear bumper (or trunk), one on each of the four doors and one on the front bumper. The impact sensors 120 can be mounted inside the door panels such that they contact the outer most panel of the doors and are thus most sensitive to any contact made with the door. The impact sensors 120 on the bumpers can be located inside the bumper or in any position where there is a rigid connection to the bumper. The impact sensors can be accelerometers or pressure sensors. The output voltage level or frequency of the impact sensor varies as a function of the force impacted on the sensor. Tilt switches can also be used for the impact sensors 120. A change in the tilt measurement can be used as an indication of an impact.

In some embodiments, the impact sensors 120 are configured to detect a person touching the vehicle, such as, for example, someone scratching the vehicle. In one embodiment, pressure sensors may be set to a sensitivity level sensitive enough to detect pressure applied to the vehicle by a person's touch and signal an impact. In another embodiment, if a door handled is moved, the impact sensor 120 of this embodiment would detect the door handle being moved and signal an impact.

The wireless transmitter 125 is used to transmit alerts when an incident is detected. The wireless transmitter 125 is also used to receive incoming signals to enable remote monitoring and control of the system. Any form of wireless communication can be used such as cellular phone systems, satellite phone systems, pager systems, WiFi systems, etc.

As skilled technologists will recognize, different numbers of the various components of the system shown in FIG. 1 can be used. Various components can be omitted, combined and repositioned, or combinations thereof.

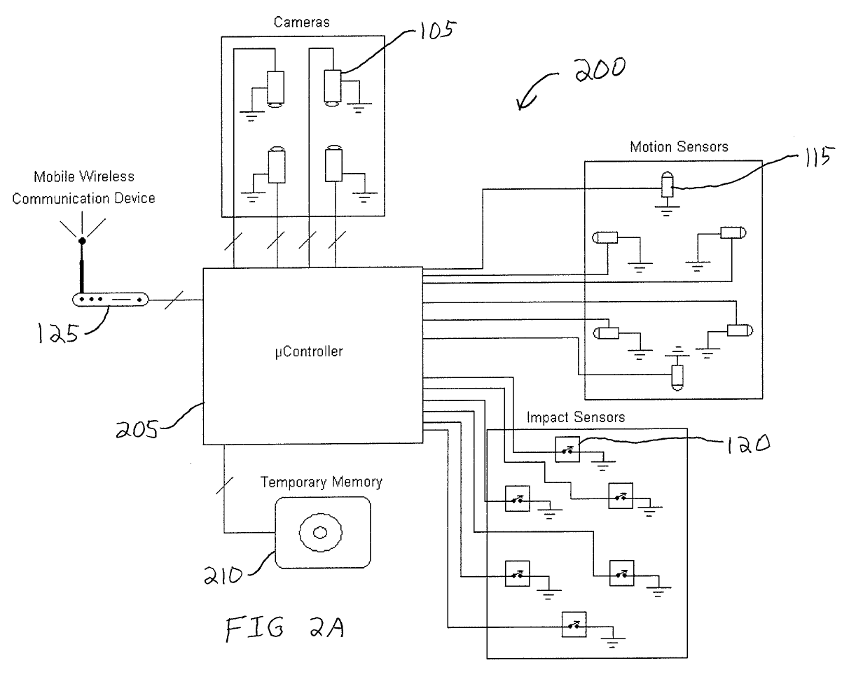

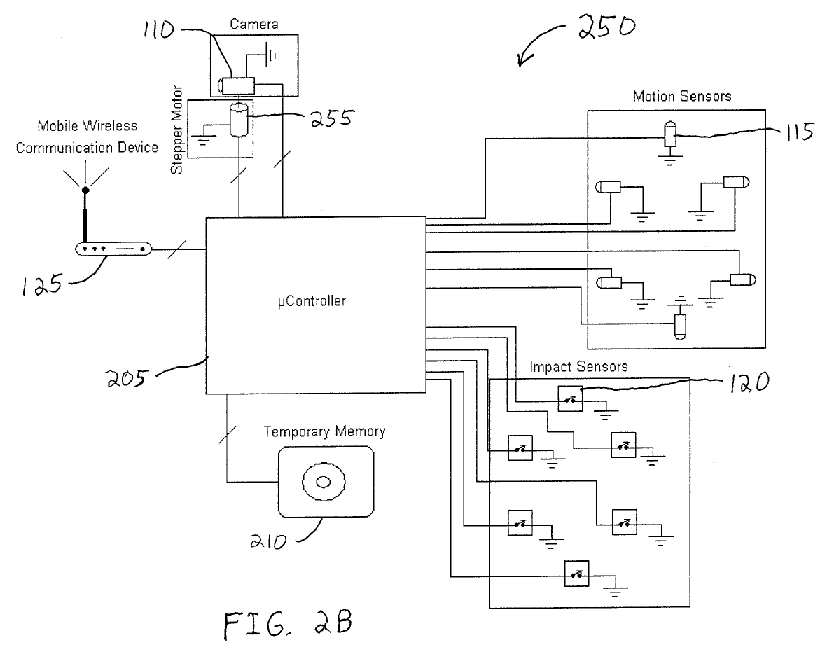

FIG. 2A is a schematic diagram of an embodiment of a multiple camera system such as illustrated in FIG. 1. The system 200 includes the fixed cameras 105, the motion sensors 115, the impact sensors 120 and the wireless transmitter 125. The fixed cameras 105, the motion sensors 115, the impact sensors 120 and the wireless transmitter are linked with a microcontroller 205. The links may be wired and/or wireless links. The microcontroller 205 is also linked with a memory module 210. The storage capacity of the memory module 210 can be in a range from about 2 gigabytes to about 300 gigabytes or larger. The microcontroller 205 may be a separate component or may be a part of one of the other components of the system 200, such as the wireless transmitter 125. In one embodiment, the microcontroller 205 is a Motorola microcontroller number MC68 HC12.

The microcontroller 205 may be any conventional general purpose single- or multi-chip microprocessor such as a Pentium® processor, Pentium II® processor, Pentium III® processor, Pentium IV® processor, Pentium® Pro processor, a 8051 processor, a MIPS® processor, a Power PC® processor, or an ALPHA® processor. In addition, the microcontroller 205 may be any conventional special purpose microprocessor such as a digital signal processor. As shown in FIG. 2, the microcontroller 205 has conventional address lines, conventional data lines, and one or more conventional control lines.

Memory refers to electronic circuitry that allows information, typically computer data, to be stored and retrieved. Memory can refer to external devices or systems, for example, disk drives or tape drives. Memory can also refer to fast semiconductor storage (chips), for example, Random Access Memory (RAM) or various forms of Read Only Memory (ROM), that are directly connected to the microcontroller 205. Other types of memory include bubble memory, flash memory and core memory.

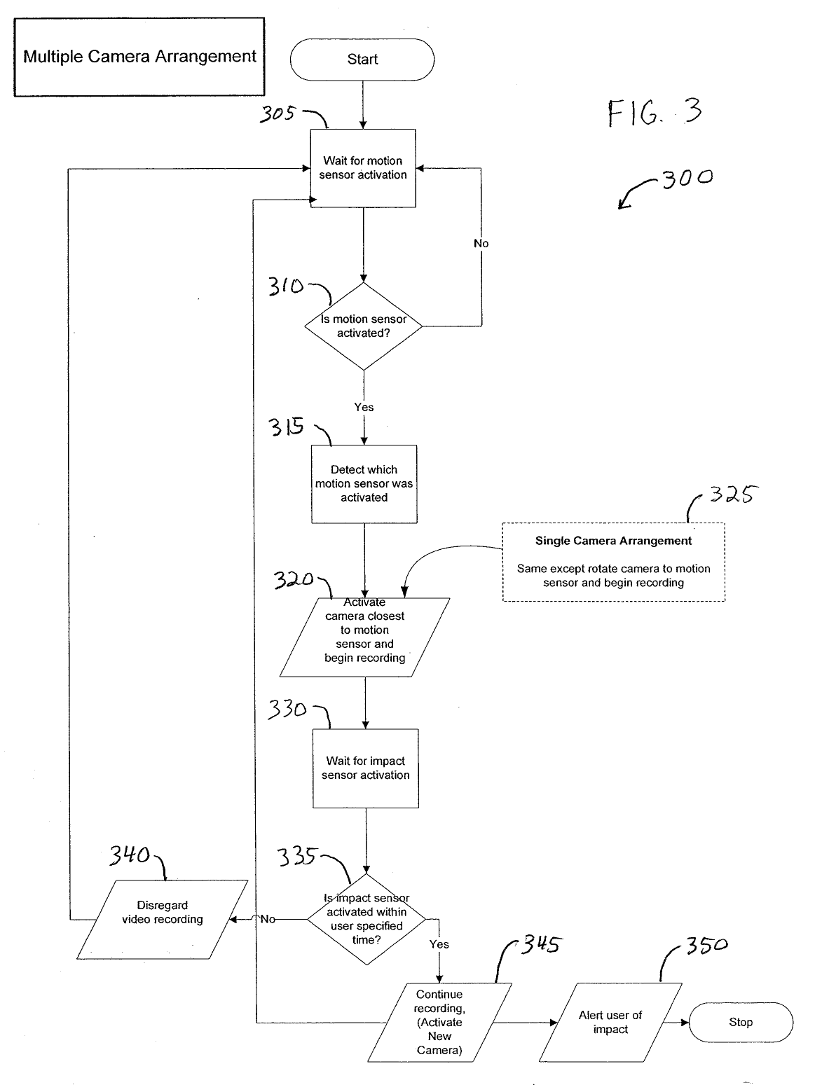

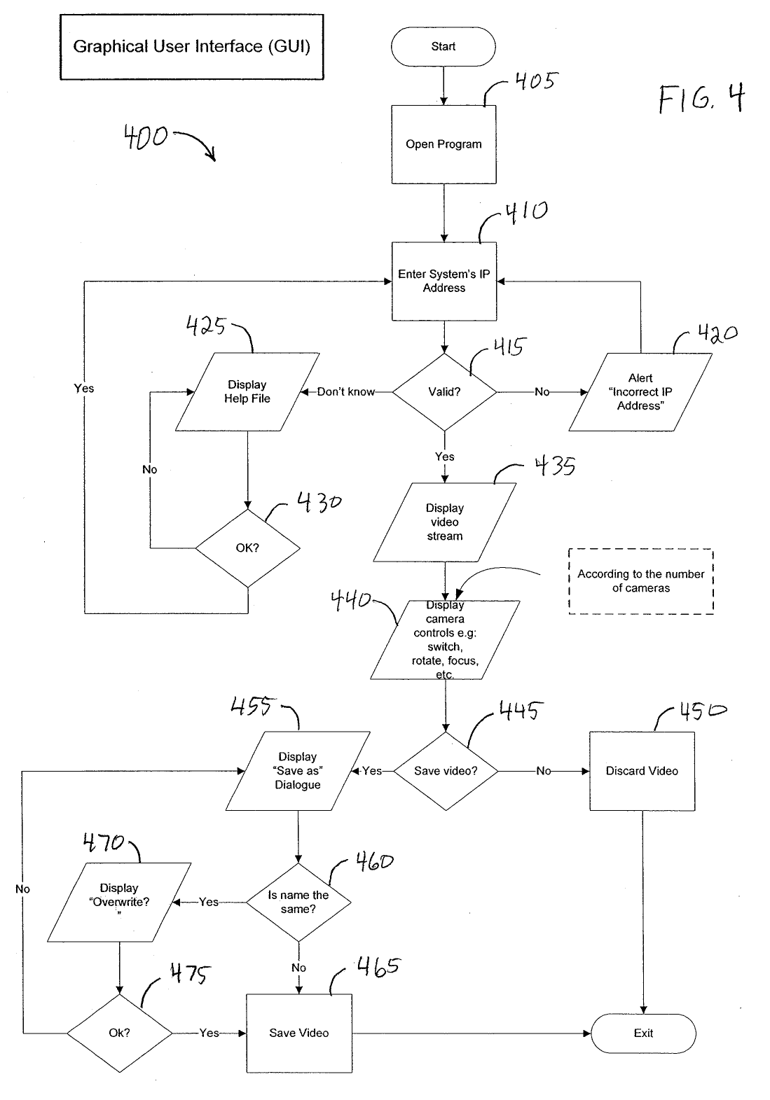

FIG. 2B is a schematic diagram of an embodiment of a rotating camera system such as illustrated in FIG. 1. Instead of four fixed cameras 105 as used in the system 200, system 250 includes a single rotating camera 110 linked to and controlled by the microcontroller 205. The rotating camera 110 includes a stepper motor 255 that is also linked to and controlled by the microcontroller 205. The other components of the system 250 are similar to the components in the system 200 of FIG. 2A. The functions performed by the microcontroller 205 in the systems 200 and 250 will now be discussed in reference to FIGS. 3 and 4.

FIG. 3 is a flowchart illustrating an example of a method 300 of capturing video of an accident in a system such as illustrated in FIG. 1. The method can be used in systems of various embodiments such as the systems 200 and 250 discussed above. With reference to FIGS. 2A, 2B and 3, the method 300 starts at step 305, where the microcontroller 205 monitors signals from the motion sensors 115 until one or more of the motion sensors 115 signals an activation event. An activation event can be anything deemed to be a potential contact event with the vehicle. After motion sensor activation, the process 300 continues to step 310. The motion sensor activation event may be required to be sustained for a minimum amount of time at the step 310. If the motion sensor remains activated for this minimum amount of time, the process 300 continues to step 315. However, if the motion sensor activation is not sustained at the step 310, the process 300 continues back to step 305. In addition to motion sensors, images or video data can be analyzed as discussed above to detect motion and trigger activation.

At the step 315, the microcontroller 205 determines which of the motion sensors 115 was activated. After determining which of the motion sensors 115 were activated, the process 300 continues to step 320, where the microcontroller 205 activates the camera in the position to best view the motion detected by the activated motion sensor. For example, in the embodiment shown in FIG. 1, if the motion sensor 115 in the right rear corner of the vehicle 100 was activated, then the fixed camera 105 in the right rear corner substantially aligned with the activated motion sensor will be activated. If one of the motion sensors 115 in the door windows was activated, then both of the fixed cameras 105 located on the opposite side of the vehicle 100 (those cameras pointed towards the activate door-window motion sensor 115) are activated. In some embodiments, all of the cameras could be activated at the step 320 regardless of which motion sensors are activated.

In the case of the system 250 with the rotating camera 110, the step 325 is performed instead of the step 320. In this case, the microcontroller 205 rotates the rotating camera 110 to point in the direction of the area being monitored by the one or more activated motion sensors 115. If multiple motion sensors are activated, the rotating camera 110 can be rotated to view one monitoring area, and after a certain amount of time, or upon deactivation of one of motion sensors 115, rotated to another monitoring area of another activated motion sensor 115.

After the camera or cameras are activated, they can remain activated while the process 300 continues at step 330, where the microcontroller waits for activation of one of the impact sensors 120. In addition to impact sensors 120, other sensors may indicate an impact event in response to a person touching the vehicle. After a period of time has passed, the process 300 continues to decision block 335 and if no indication of an impact was received by the microcontroller 205, the process 300 continues to step 340. At the step 340, any video that was captured is discarded in order to free up space in the memory 210. The process 300 then proceeds to the step 304 to wait for the motion sensor activation.

Returning to the decision block 335, if an impact sensor (or other sensor such as one detecting a person touching the vehicle) is activated, the process 300 continues to step 345. If the location of the activated impact sensor is consistent with the area of the vehicle currently being recorded by the activated cameras, these cameras remain activated and recording during and after the impact event. If one or more of the activated impact sensors are in a location of the vehicle not being recorded by a camera, other cameras may be activated at the step 345 to capture the video of the impact. In the case of the system 250 with the rotating camera 110, the camera can be rotated to a new location at the step 345 depending on the location of the one or more activated impact sensors 120. As discussed above, the rotating camera 110 can be rotated to different regions, spending a certain amount of time in the different regions, if multiple impact sensors are activated.

If one of the impact sensors 120 is activated before one of the motion sensors is activated, the process 400 can bypass the steps 305, 310, 315 and 320 and proceed directly to steps 335 and 345 to activate one or more of the cameras based on the location of the activated impact sensors. Blind spots in the field of view of the motion sensors and/or the cameras may be unavoidable in some vehicles. In these cases, activation of the impact sensors can be used to activate the cameras, thereby possibly retrieving some video data of the impact event.

After the impact sensors indicate that the impact event has concluded, or after a predetermined amount of time, the process 300 continues to step 350, where an alert email is sent to the user via the wireless transmitter 125. In one embodiment, the email includes a video attachment of video captured by one or more cameras before, during and/or after the impact event. After alerting the user at the step 350, the process 300 can stop or return to the step 305 to wait for the next motion sensor activation.

In addition to the alert sent at the step 345, some embodiments can send an alert upon the activation of the motion sensors at the step 305. In these embodiments, the alert may be in the form of an SMS message to a mobile device of the user. In addition to activating the cameras in response to detecting a potential contact event, the microcontroller 205 may also activate one or more cameras on a random or periodic basis without receiving an indication of a potential contact event at the step 305. It should be noted that some of the steps of the process 300 may be combined, omitted, rearranged or any combination thereof.

FIG. 4 is a flowchart illustrating an example of a method of monitoring the surroundings of a vehicle in a system such as illustrated in FIG. 1. Process 400 can be performed on a computing device such as a PC, a PDA, a cell phone, etc., to enable a user to remotely monitor a vehicle including a system such as the systems of FIGS. 1, 2A and 2B. The process 400 shows the flow of a GUI (graphical user interface) program that a user can use to control the various components of the systems discussed above.

At step 405, the user opens a program for executing the process 400. The process 400 continues to step 410 where the GUI queries the user for an IP address of the system. The IP address may be assigned to the wireless transmitter 125 by a wireless service provider. In this way, the user can control the entire system by communicating with the wireless transmitter 125 with the microcontroller 205 serving as a router in the system to communicate commands to the cameras, the sensors, etc. After the IP address is entered by the user, the process 400 verifies that this is a valid IP address at step 415. Valid IP addresses may be any that are of an acceptable format, or there may be a list of valid IP addresses previously compiled by the user. If the IP address is valid, the process continues to step 435. If the IP address is not valid, the GUI displays an alert message to the user indicating that the IP address is incorrect or invalid and the process 400 returns back to step 410. If the process 400 does not recognize the IP address entered by the user (e.g., it is an incorrect format), the process 400 continues at step 425 where a help file is displayed to the user. The help file, or different portions of the help file, are displayed to the user until the user indicates that he is okay with the instructions at step 430 and the process 400 returns to step 410.

After an Internet connection is made with the IP address of the system, the process 300 receives and displays a video stream from the system at step 435. The system may default to transmitting a video stream of one of the cameras or more than one of the cameras. While the video stream is being displayed at step 435, the process 400 continues to step 440 where the GUI displays a camera control menu. This may be in the form of a hot link that the user may click on. Camera controls including zoom, rotate, focus, etc., may be presented. In this way, the user can control what he is monitoring. After the user is done monitoring the videos, he can elect to quit the video stream and the process 400 continues to step 405 where the GUI queries the user if they wish to save the video data. If the user elects not to save the video data, the process 400 discards the video data at step 450 and exits the program. If the user elects to save the video data, the process 400 proceeds to step 455, where the GUI queries the user with a “save as” dialogue box to request the name of a file to save the data.

At step 460, if the name input by the user is the same as another file already saved, the process 400 continues to step 470 where the user is queried if they wish to overwrite the existing file. If the user wishes to overwrite the existing file, the video is saved at step 465 and the process 400 is exited. If the user does not wish to overwrite the existing file, the process proceeds back to step 455. Returning to step 460, if the name is different than other files already save, the video data is saved at step 465 and the process 400 is exited. It should be noted that some of the steps of the process 300 may be combined, omitted, rearranged or any combination thereof.

The microprocessors of the systems discussed above contains executable instructions comprised of various modules for executing the various functions performed by the systems of FIGS. 1, 2A and 2B in executing the processes 300 and 400 discussed above. For example, the modules may include a motion detection system module for controlling and receiving data from the motion sensors, an impact detection system module for controlling and receiving data from the impact sensors, a video control module for controlling and receiving data from the cameras, and a communication module for transmitting and/or receiving data using the wireless transmitter. As can be appreciated by one of ordinary skill in the art, each of the modules comprise various sub-routines, procedures, definitional statements, and macros. Each of these modules are typically separately compiled and linked into a single executable program. Therefore, the preceding description of each of the systems or subsystems is used for convenience to describe the functionality of the modules. Thus, the processes that are undergone by each of the modules may be arbitrarily redistributed to one of the other modules, combined together in a single module, or made available in a shareable dynamic link library. Further each of the modules could be implemented in hardware.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A system comprising:
one or more cameras mounted on a vehicle;
a wireless transmitter; and
a contact detection system comprising a processor in electrical communication with the one or more cameras, the wireless transmitter and one or more sensors configured to detect a potential contact event, wherein the processor is configured to receive an indication in response to one or more of the sensors detecting the potential contact event, activate at least one of the cameras to capture video data subsequent to receiving the indication of the potential contact event, determine whether or not the contact event occurs and discard the captured video data in response to determining that the contact event did not occur.

2. The system of claim 1, wherein the wireless transmitter is configured to transmit an alert via a text message to a mobile communication device subsequent to receiving the indication of the potential contact event.

3. The system of claim 1, wherein the wireless transmitter is configured to transmit an email message including a video attachment in response to determining that the contact event did occur, wherein the video attachment comprises one or more of video captured before, during and after the contact event.

4. The system of claim 1, wherein one of the sensors is configured to detect a person touching the vehicle and the processor is further configured to determine that the contact event occurred subsequent to the sensor detecting the person touching the vehicle.

5. The system of claim 1, wherein one of the sensors is a motion sensor configured to detect the potential contact event by detecting motion of an object.

6. The system of claim 1, wherein one of the sensors is an impact sensor configured to detect an object impacting the vehicle the processor is further configured to determine that the contact event occurred subsequent to the impact sensor detecting the object impacting the vehicle.

7. The system of claim 1, wherein the processor is further configured to activate the one or more cameras on a random or periodic basis without receiving the indication of the potential contact event, and to store video data captured by the one or more cameras.

8. A system comprising:
a camera rotatably mounted on a vehicle; and
a motion detection system comprising a processor in electrical communication with the camera, and one or more motion sensors configured to detect motion of an object in the vicinity of the vehicle, wherein the processor is configured to receive an indication from one or more of the sensors subsequent to detecting the motion of the object, to rotate the camera to point in the direction of the area monitored by the motion sensor that detected the motion of the object, and to activate the camera subsequent to receiving the motion indication.

9. The system of claim 8, further comprising:
one or more impact sensors configured to detect an object impacting the vehicle, wherein the processor is further configured to receive an indication of the impact from the impact sensors subsequent to detecting the impact; and
a wireless transmitter configured to transmit an alert via a text message to a mobile communication device subsequent to receiving the impact indication, and to transmit an email message including a video attachment, wherein the video attachment comprises one or more of video captured by the camera before, during and after the detection of the impact.

10. The system of claim 9, wherein the processor is further configured to deactivate the camera in response to the impact sensor not detecting the impact within a time period after detecting the motion of the object; and to discard the video captured by the camera before transmitting the email message.

11. A method comprising:
detecting a potential contact event of a vehicle;
receiving an indication of the detection of the potential contact event;
activating one or more cameras to capture video data subsequent to receiving the indication of the potential contact event;
determining whether or not the contact event occurs; and
discarding the captured video data in response to determining that the contact event did not occur.

12. The method of claim 11, further comprising transmitting an alert via a text message to a mobile communication device subsequent to the receiving the indication of the potential contact event.

13. The method of claim 11, further comprising transmitting an email message including a video attachment in response to determining that the contact event did occur, wherein the video attachment comprises one or more of video captured before, during and after the contact event.

14. The method of claim 11, wherein determining whether or not the contact event occurs comprises detecting a person touching the vehicle.

15. The method of claim 11, wherein detecting the potential contact event comprises detecting motion of an object.

16. The method of claim 11, wherein determining whether or not the contact event occurs comprises detecting an object impacting the vehicle.

17. The method of claim 11, further comprising activating the one or more cameras on a random or periodic basis without receiving the indication of the potential contact event, and to store video data captured by the one or more cameras.

18. A method comprising:
detecting motion of an object in the vicinity of a vehicle with one or more motion sensors;
receiving an indication from at least one of the motion sensors subsequent to detecting the motion of the object;
rotating a camera to point in the direction of the area monitored by the motion sensor that detected the motion of the object; and
activating the camera subsequent to receiving the motion indication.

19. The method of claim 18, further comprising:
detecting an object impacting the vehicle;
receiving an impact indication subsequent to detecting the impact; and
transmitting an alert via a text message to a mobile communication device subsequent to receiving the impact indication, and to transmit an email message including a video attachment, wherein the video attachment comprises one or more of video captured by the camera before, during and after the detection of the impact.

20. The method of claim 19, further comprising:
deactivating the camera in response to the impact sensor not detecting the impact within a time period after detecting the motion of the object; and
discarding the video captured by the camera before transmitting the email message.
